(19) United States
(12) Patent Application Publication
(10) Pub. No.: US 2019/0120346 A1
(43) Pub. Date: Apr. 25, 2019

(54) EXPANSION/CONTRACTION MECHANISM AND FOUR-LEGGED ROBOT

(71) Applicant: Sony Corporation, Tokyo (JP)

(72) Inventor: Kazuo Hongo, Kanagawa (JP)

(73) Assignee: Sony Corporation, Tokyo (JP)

(21) Appl. No.: 16/302,674

(22) PCT Filed: May 12, 2017
(86) PCT No.: PCT/JP2017/018083

§ 371 Date: Nov. 19, 2018

(30) Foreign Application Priority Data
Jul. 6, 2016 (JP) 2016-134178

(51) Int. Cl. F16H 21/44; B25J 18/02; B62D 57/032

(52) U.S. Cl. CPC F16H 21/44; B62D 57/032; B25J 18/02

(57) ABSTRACT

An expansion/contraction mechanism includes at least three expansion/contraction members that are formed by coupling respective ends of a plurality of link members sequentially rotatably to each other, and that are capable of performing expansion/contraction operation in predetermined expansion/contraction directions by adjusting an angle between the mutually-coupled link members; and a plurality of connection members that are provided with being aligned along the expansion/contraction directions in a space surrounded by the at least three expansion/contraction members arranged in a state in which the expansion/contraction directions face a substantially same direction, and that are configured to connect the at least three expansion/contraction members to each other. Each of the plurality of connection members pivotally supports the respective link members of the at least three expansion/contraction members that are positioned in a direction orthogonal to the expansion/contraction directions when viewed from itself, so as to be rotatable around itself.

### TECHNICAL FIELD

The present disclosure relates to an expansion/contraction mechanism and a four-legged robot.

### BACKGROUND ART

For implementing an expansion/contraction operation of an arm portion or a leg portion of a robot, a rotational mechanism or a linear motion mechanism is used. For example, in a case where the arm portion and the leg portion are formed into a structure imitating a human, it is advantageous to form a joint portion thereof by a rotational mechanism. This is because natural appearance can be obtained, and in addition, the number of components can be reduced. On the other hand, in this configuration, there is concern that, in implementing a target operation of a fingertip or a toe, the joint portion interferes with peripheries, and a smooth operation is disturbed. For example, when an assumption is made on a case where a humanoid robot having a joint portion of a leg portion that is formed by a rotational mechanism goes up or down stairs or a ladder, a region corresponding to a knee joint thereof performs a bending operation, and the bent region is projected forward to possibly interfere with the stairs or the ladder.

To respond to this concern, it is effective to form an arm portion or a leg portion by a linear motion mechanism, and perform an expansion/contraction operation of the arm portion or the leg portion using the linear motion mechanism. As a linear motion mechanism, for example, a mechanism that uses a slider structure or a pantograph structure is known. In addition, there is proposed a linear motion mechanism in which an arm portion is formed by coupling a plurality of block members in series, and an expansion/contraction operation of the arm portion is implemented in such a manner as to roll up the block member group (Patent Literature 1).

### CITATION LIST

### Patent Literature

Patent Literature 1: JP 5317362B

### DISCLOSURE OF INVENTION

### Technical Problem

Nevertheless, in the slider structure, it is difficult to obtain a high expansion/contraction ratio, and in addition, the weight thereof tends to be relatively large. In addition, in the pantograph structure, although a high expansion/contraction ratio can be obtained, it is difficult to obtain a high strength. Moreover, in the linear motion mechanism described in Patent Literature 1, because a space for storing the rolled-up block members is required, space efficiency is bad, and use application thereof becomes limitative. For example, it is difficult to apply the linear motion mechanism to a moving robot.

In view of the foregoing, the present disclosure proposes an expansion/contraction mechanism and a four-legged robot including the expansion/contraction mechanism in a leg portion that are novel and improved, and can realize a higher strength and a higher expansion/contraction ratio, with a simpler configuration.

### Solution to Problem

According to the present disclosure, there is provided an expansion/contraction mechanism including: at least three expansion/contraction members that are formed by coupling respective ends of a plurality of link members sequentially rotatably to each other, and that are capable of performing expansion/contraction operation in predetermined expansion/contraction directions by adjusting an angle between the mutually-coupled link members; and a plurality of connection members that are provided with being aligned along the expansion/contraction directions in a space surrounded by the at least three expansion/contraction members arranged in a state in which the expansion/contraction directions face a substantially same direction, and that are configured to connect the at least three expansion/contraction members to each other. Each of the plurality of connection members pivotally supports the respective link members of the at least three expansion/contraction members that are positioned in a direction orthogonal to the expansion/contraction directions when viewed from itself, so as to be rotatable around itself.

In addition, according to the present disclosure, there is provided a four-legged robot including four leg portions each formed by an expansion/contraction mechanism. The expansion/contraction mechanism includes at least three expansion/contraction members that are formed by coupling respective ends of a plurality of link members sequentially rotatably to each other, and that is capable of performing expansion/contraction operation in predetermined expansion/contraction directions by adjusting an angle between the mutually-coupled link members, and a plurality of connection members that are provided with being aligned along the expansion/contraction directions in a space surrounded by the at least three expansion/contraction members arranged in a state in which the expansion/contraction directions face a substantially same direction, and that are configured to connect the at least three expansion/contraction members to each other. Each of the plurality of connection members pivotally supports the respective link members of the at least three expansion/contraction members that are positioned in a direction orthogonal to the expansion/contraction directions when viewed from itself, so as to be rotatable around itself.

According to the present disclosure, respective ends of a plurality of link members are sequentially rotatably coupled to each other, and at least three expansion/contraction members that can perform an expansion/contraction operation in a predetermined expansion/contraction direction by an angle formed by the mutually-coupled link members, being adjusted are provided. Then, an expansion/contraction mechanism is formed by these at least three expansion/contraction members being arranged so as to surround a predetermined space extending in the expansion/contraction direction, and being connected to each other. Because the configuration of each expansion/contraction member is very simple, as the entire expansion/contraction mechanism, a simpler configuration can also be realized. In addition, in each expansion/contraction member, because an expansion/contraction operation similar to that in the pantograph structure can be performed, as the entire expansion/contraction mechanism, a high expansion/contraction ratio can also be realized. Furthermore, by arranging the expansion/contraction members as described above, a higher strength can be realized as the entire expansion/contraction mechanism.

### Advantageous Effects of Invention

As described above, according to the present disclosure, it becomes possible to realize a higher strength and a higher expansion/contraction ratio, with a simpler configuration. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram for illustrating a configuration of an expansion/contraction mechanism according to the present embodiment, and describing an expansion/contraction operation thereof.

FIG. 2 is a diagram for illustrating a configuration of an expansion/contraction mechanism according to the present embodiment, and describing an expansion/contraction operation thereof.

FIG. 3 is a diagram for illustrating a configuration of an expansion/contraction mechanism according to the present embodiment, and describing an expansion/contraction operation thereof.

FIG. 4 is a diagram for illustrating a configuration of an expansion/contraction mechanism according to the present embodiment, and describing an expansion/contraction operation thereof.

FIG. 5 is a diagram illustrating a configuration of an expansion/contraction mechanism that uses a ring-shaped connection member, which is one modified example of the present embodiment.

FIG. 6 is a diagram illustrating a configuration of a parallel link mechanism according to the present embodiment.

FIG. 7 is a diagram illustrating an example of an operation of a parallel link mechanism 1 according to the present embodiment.

FIG. 8 is a diagram illustrating an example of an operation of the parallel link mechanism 1 according to the present embodiment.

FIG. 9 is a diagram illustrating an example of an operation of the parallel link mechanism 1 according to the present embodiment.

FIG. 10 is a diagram illustrating a configuration of a four-legged robot according to the present embodiment.

FIG. 11 is a diagram for illustrating a configuration of a parallel link mechanism to which an expansion/contraction mechanism including four expansion/contraction members is applied, which is one modified example of the present embodiment, and describing an expansion/contraction operation thereof.

FIG. 12 is a diagram for illustrating a configuration of a parallel link mechanism to which an expansion/contraction mechanism including four expansion/contraction members is applied, which is one modified example of the present embodiment, and describing an expansion/contraction operation thereof.

FIG. 13 is a diagram for illustrating a configuration of a parallel link mechanism to which an expansion/contraction mechanism including four expansion/contraction members is applied, which is one modified example of the present embodiment, and describing an expansion/contraction operation thereof.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that, in the drawings illustrated in the present disclosure, for the sake of description, a size of a partial constituent element is exaggeratingly represented in some cases. A relative size of each member illustrated in each drawing does not always accurately represent an actual magnitude relation between members.

The description will be given in the following order.

1. Configuration of Expansion/Contraction Mechanism

2. Application Example
2-1. Parallel Link Mechanism
2-2. Four-Legged Robot
2-3. Other Application Examples

3. Modified Example

4. Supplement

### 1. Configuration of Expansion/Contraction Mechanism

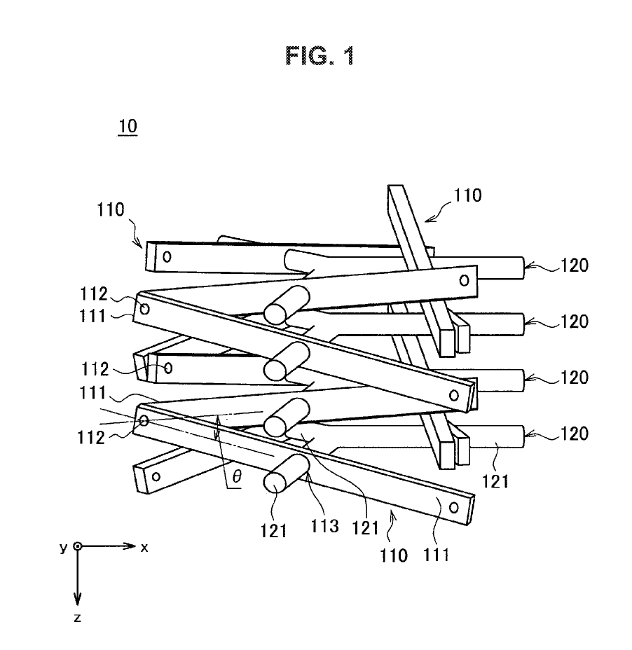

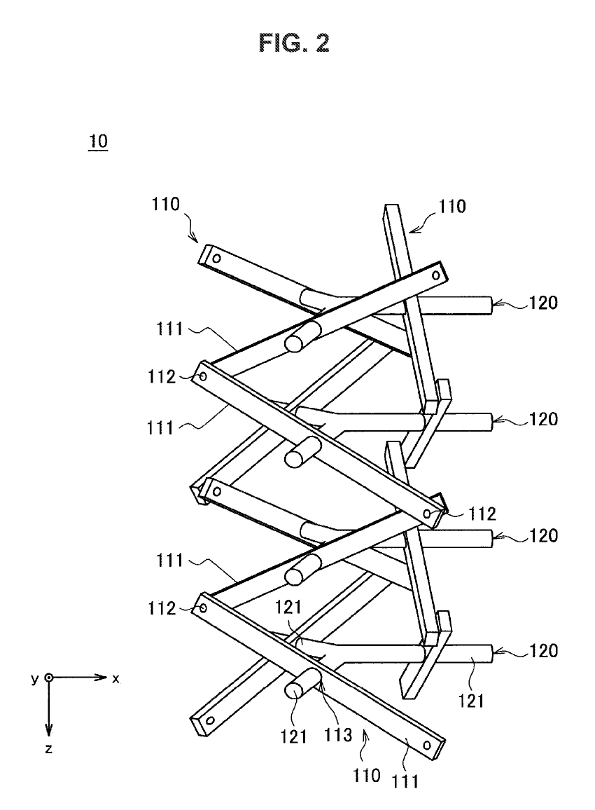

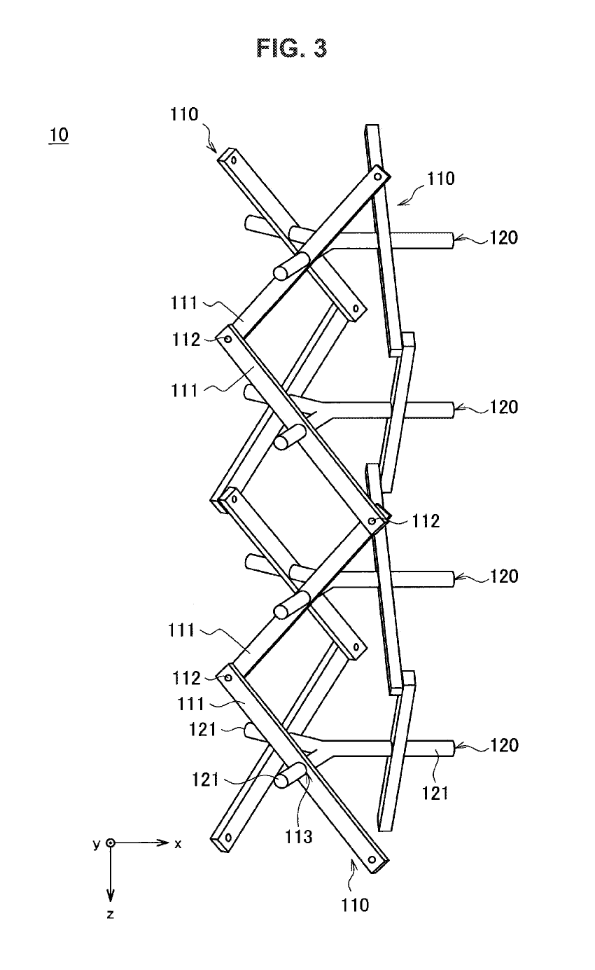

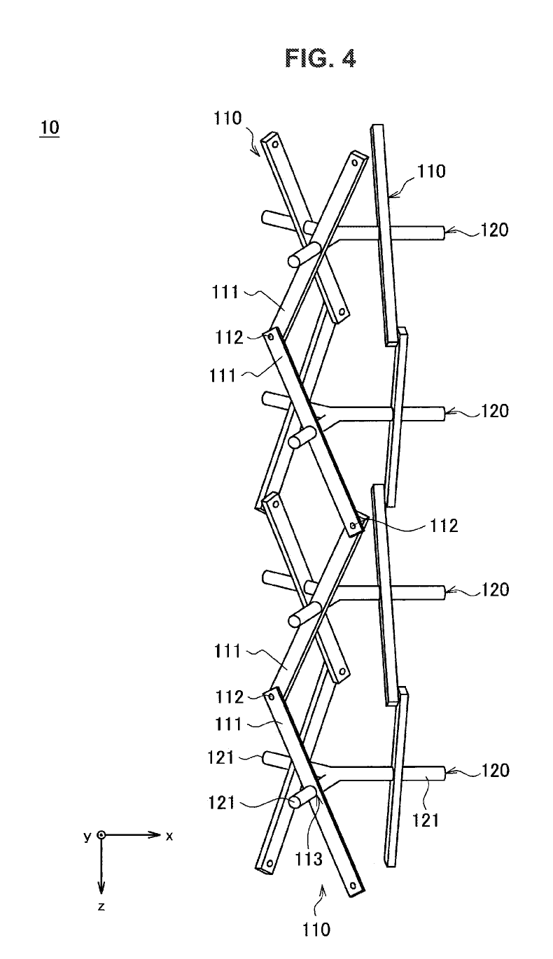

With reference to FIGS. 1-4, a configuration of an expansion/contraction mechanism according to a preferred embodiment of the present disclosure will be described, and an expansion/contraction operation thereof will be described. FIGS. 1-4 are diagrams for illustrating a configuration of an expansion/contraction mechanism according to the present embodiment, and describing an expansion/contraction operation thereof.

FIGS. 1-4 illustrate a state in which an expansion/contraction mechanism 10 according to the present embodiment expands and contracts. As illustrated in FIGS. 1-4, the expansion/contraction mechanism 10 according to the present embodiment is an expansion/contraction mechanism with one degree of freedom that can expand and contract in one direction (i.e. linear motion expansion/contraction mechanism). Note that, hereinafter, an expansion/contraction direction of the expansion/contraction mechanism 10 will also be referred to as a z-axis direction. In addition, two directions orthogonal to each other in a plane vertical to the z-axis direction are also respectively referred to as an x-axis direction and a y-axis direction.

Referring to FIGS. 1-4, the expansion/contraction mechanism 10 according to the present embodiment includes three expansion/contraction members 110 that can expand and contract in the z-axis direction, and a plurality of connection members 120 that are inserted between these three expansion/contraction members 110, and connect these three expansion/contraction members 110 to each other. Because the three expansion/contraction members 110 all have similar configurations, a configuration of one expansion/contraction member 110 will now be described as a representative.

The expansion/contraction member 110 is formed by respective ends of a plurality of link members 111 being sequentially rotatably coupled by pins 112. In the example illustrated in the drawings, the expansion/contraction member 110 is formed by four link members 111.

The plurality of link members 111 all have substantially the same elongated plate shape. In a state in which respective ends of plate surfaces of adjacent two link members 111 (for the convenience of the description, in the description of the configuration of the expansion/contraction member 110, also respectively referred to as a first link member 111 and a second link member 111) are overlapped, the overlapped region is fastened by the pin 112, whereby the first link member 111 and the second link member 111 are rotatably coupled to each other. An end plate surface of further another link member 111 (for the convenience of the description, in the description of the configuration of the expansion/contraction member 110, also referred to as a third link member 111) is overlapped with an end plate surface of one (e.g. the second link member 111) of these coupled first link member 111 and the second link member 111, to which the other link member 111 (i.e. the first link member 111) is not coupled, and the overlapped region is fastened by the pin 112. In this manner, the expansion/contraction member 110 is formed by the link members 111 being sequentially coupled.

At this time, coupling of the link members 111 are performed in such a manner that a surface on which the third link member 111 is overlapped with the second link member 111 becomes the same surface as a surface on which the first link member 111 is overlapped with the second link member 111. In other words, with respect to the same plate surface of the second link member 111, the first link member 111 and the third link member 111 are overlapped and coupled. By using such a coupling method, in the expansion/contraction member 110, a thickness in a direction in which the link members 111 are overlapped becomes the same as a thickness corresponding to an overlap of the two link members 111. Thus, the expansion/contraction member 110 can be formed to be thin. In other words, the expansion/contraction mechanism 10 formed by these expansion/contraction members 110 being combined can also be downsized. Nevertheless, the present embodiment is not limited to this example, and in a case where making the thickness of the expansion/contraction members 110 thinner needs not be considered, plate surfaces on which the first link member 111 and the third link member 111 are overlapped with the second link member 111 may be different from each other.

By the configuration in which the link members 111 are sequentially coupled, the expansion/contraction members 110 can perform an expansion/contraction operation like a pantograph structure (also referred to as a magic hand structure). Specifically, by operating the expansion/contraction members 110 so as to be folded in such a manner that an extending direction of the plurality of link members 111 comes closer to a direction substantially vertical to the z-axis direction (i.e. in such a manner that an angle θ formed by mutually-coupled link members 111 (hereinafter, also referred to as a link member coupling angle θ) comes closer to zero degree), the expansion/contraction members 110 contract. On the other hand, by operating the expansion/contraction members 110 so as to expand in such a manner that an extending direction of the plurality of link members 111 comes closer to a direction substantially parallel to the z-axis direction (i.e. in such a manner that the link member coupling angle θ comes closer to 180 degrees), the expansion/contraction members 110 expand.

Here, in the above-described expansion/contraction operation, the plurality of link members 111 included in the expansion/contraction member 110 operate in substantially one plane. Hereinafter, for the convenience of the description, the plane will be referred to as an expansion/contraction operation plane. The expansion/contraction operation plane corresponds to a plane orthogonal to a rotational axis direction around which, with respect to one link member 111, another link member 111 is rotated via the pin 112 in the expansion/contraction members 110 (i.e. an insertion direction of the pin 112). In addition, the expansion/contraction operation plane is a plane parallel to both of an extending direction of link members 111 and the expansion/contraction direction (the z-axis direction) of the expansion/contraction members 110.

The three expansion/contraction members 110 all have the same configurations. Then, the three expansion/contraction members 110 are arranged at substantially the same positions in the z-axis direction so as not to contact each other and so as to surround a predetermined space extending in the z-axis direction, in a state in which all of their expansion/contraction directions face the z-axis direction. In addition, at this time, the three expansion/contraction members 110 are arranged in such a manner that their three expansion/contraction operation planes form a substantially regular triangular shape in an x-y plane.

Nevertheless, the configuration illustrated in the drawings is merely an example, and the arrangement of the expansion/contraction members 110 is not limited to this example. In the present embodiment, the three expansion/contraction members 110 are only required to be arranged, in a state in which their expansion/contraction directions face substantially the same direction, so as not to contact each other and so as to surround a predetermined space extending in the expansion/contraction direction (i.e. in such a manner that the three expansion/contraction operation planes form a triangular shape in the x-y plane). In the present embodiment, as long as the three expansion/contraction members 110 are arranged in this manner, arrangement positions of the three expansion/contraction members 110 may be arbitrary positions. For example, the three expansion/contraction members 110 may be arranged in a state in which their positions in the z-axis direction are shifted from each other. In addition, for example, the three expansion/contraction members 110 need not be arranged in such a manner that their three expansion/contraction operation planes form a substantially regular triangular shape in the x-y plane (i.e. at positions equally rotated by 120 degrees when viewed from the z-axis direction), and may be arranged so as to form another triangular shape such as an isosceles triangle (i.e. at positions rotated by an arbitrary angle when viewed from the z-axis direction).

Nevertheless, when positions in the z-axis direction of the three expansion/contraction members 110 are shifted from each other, an end portion of the expansion/contraction mechanism 10 has such a shape that any of the expansion/contraction members 110 protrudes. Thus, from the viewpoint of downsizing of the expansion/contraction mechanism 10, these three expansion/contraction members 110 are preferably arranged in such a manner that their positions in the z-axis direction become substantially the same. In addition, from the viewpoint of downsizing of the expansion/contraction mechanism 10, the three expansion/contraction members 110 are preferably arranged in proximity to each other as far as possible without contacting each other. Then, when the three expansion/contraction members 110 are arranged in proximity to each other as far as possible without contacting each other, these three expansion/contraction members 110 are arranged in such a manner that their three expansion/contraction operation planes form a substantially regular triangular shape in the x-y plane. In other words, FIGS. 1-4 illustrate a configuration example in which the expansion/contraction mechanism 10 can be downsized more as described above.

In addition, at this time, as illustrated in the drawings, the three expansion/contraction members 110 are preferably arranged in such a manner that extending directions of link members 111 included in each of the expansion/contraction members 110 become the same direction between these three expansion/contraction members 110. In other words, as illustrated in the drawings, the three expansion/contraction members 110 are preferably arranged so as to be rotationally symmetric about a z-axis in a case where the three expansion/contraction members 110 are arranged in such a manner that the three expansion/contraction operation planes form a substantially regular triangular shape in the x-y plane. For example, in the configuration illustrated in the drawings, in a case where one expansion/contraction member 110 is arranged in a reversed manner with respect to its expansion/contraction operation plane, by an expansion/contraction operation, link members 111 easily interfere with link members 111 of other adjacent expansion/contraction members 110. Thus, for arranging the expansion/contraction members 110 in more proximity to each other while avoiding interference of link members 111 between other adjacent expansion/contraction members 110, as described above, the three expansion/contraction members 110 are preferably arranged in such a manner that extending directions of link members 111 included in each of the expansion/contraction members 110 become the same direction between these three expansion/contraction members 110.

The plurality of connection members 120 are provided in a space surrounded by the three expansion/contraction members 110 arrange as described above. The connection members 120 are provided as many as the number (four in the example illustrated in the drawings) of link members 111 included in one expansion/contraction member 110, and in addition, the plurality of connection members 120 are arranged at substantially equal intervals along the z-axis direction at positions corresponding to the respective link members 111. The expansion/contraction mechanism 10 is formed by the three expansion/contraction members 110 being connected to each other by the plurality of connection members 120.

The plurality of connection members 120 have substantially the same shapes, and are arranged in substantially similar orientations with respect to the three expansion/contraction members 110. Specifically, each of the connection members 120 has a substantially Y shape in the x-y plane, and is arranged in such a manner that three protruding portions 121 respectively protrude toward the three expansion/contraction members 110. Each of the link members 111 is provided with an opening portion 113 at a substantially center of the plate surface, and the protruding portions 121 of each of the connection members 120 are inserted into the opening portions 113 of the respective link members 111 that are positioned in the x-y plane including themselves. The opening portion 113 is provided with a bearing, and each of the link members 111 is pivotally supported by the protruding portion 121 of the connection member 120 so as to be rotatable around the opening portion 113.

The configuration of the expansion/contraction mechanism 10 has been described above. According to the configuration described above, in the expansion/contraction mechanism 10, by causing the link members 111 in the expansion/contraction members 110 to move in the z-axis direction in conjunction (i.e. causing all of a plurality of link member coupling angles θ to change in a synchronized manner) by applying, to any of the link members 111 of any of the expansion/contraction members 110, force for moving the link member 111 in the z-axis direction, an expansion/contraction operation in the z-axis direction of the entire expansion/contraction mechanism 10 can be performed. The structure of the expansion/contraction mechanism 10 can be said to be obtained by improving an existing pantograph structure, and can realize a high expansion/contraction ratio similarly to the pantograph structure. In other words, while the expansion/contraction mechanism 10 being compact in a contracted form, a maximum length (expansion/contraction length) that is obtainable when the expansion/contraction mechanism 10 is expanded or contracted can be made longer.

In the present embodiment, a method of applying the force for expanding or contracting the expansion/contraction mechanism 10 (hereinafter, also referred to as expansion/contraction force) and a position to which the force is applied may be arbitrary method and position. For example, the expansion/contraction force may be applied by a human from the outside. In this case, for example, a use mode as in a so-called toy magic hand, in which an operating portion including a mechanism for applying expansion/contraction force to a link member 111 is provided at one end of the expansion/contraction mechanism 10, can be assumed.

Alternatively, the expansion/contraction mechanism 10 may be formed in such a manner that an actuator is provided on the protruding portion 121 of the connection member 120 that is to be inserted into the opening portion 113 of the link member 111, and rotation of the link member 111 around the opening portion 113 is performed by the actuator. In this case, a control device for controlling driving of the actuator is additionally provided, and by the control from the control device, the link member 111 is rotated around the opening portion 113 via the actuator, whereby expansion/contraction force can be applied. A control amount of the actuator may be automatically set by the control device in accordance with a predetermined program, or may be appropriately calculated and obtained by the control device in such a manner that a desired operation can be implemented in accordance with a command issued by an operator from the outside. Note that, as described above, in the expansion/contraction mechanism 10, because application of expansion/contraction force to one link member 111 operates all the link members 111 in conjunction, the actuator is only required to be provided on at least one of the opening portions 113 of the plurality of link members 111 existing in the expansion/contraction mechanism 10, and an installation position thereof and the number of actuators may be arbitrary position and number.

Alternatively, ball screws may be provided between link members 111 included in the expansion/contraction members 110. By the ball screws being driven by an actuator or a hand of a human so as to adjust distances between the link members 111, expansion/contraction force can be applied to the expansion/contraction mechanism 10. Also in this case, similarly to the above-described actuator, for applying expansion/contraction force to the expansion/contraction mechanism 10, a ball screw is only required to be provided in at least one place between link members 111 of at least one expansion/contraction member 110, and an installation position thereof and the number of ball screws may be arbitrary position and number.

Here, in the expansion/contraction mechanism 10, an expansion/contraction operation similar to an existing pantograph structure can be implemented. Nevertheless, the expansion/contraction mechanism 10 has features different from the existing pantograph structure in the following points.

As a first feature, the expansion/contraction mechanism 10 can have a higher strength than the existing pantograph structure. In the configuration of the existing pantograph structure, generally only one structure in which link members are sequentially coupled (i.e. structure corresponding to the expansion/contraction member 110 in the expansion/contraction mechanism 10) is provided, or two structures are provided in such a manner that their expansion/contraction operation planes face each other. Accordingly, the existing pantograph structure has a disadvantage of being relatively vulnerable to force in a direction orthogonal to the expansion/contraction direction, such as force for bending the pantograph structure, and twisting around the expansion/contraction direction. On the other hand, in the configuration of the expansion/contraction mechanism 10, the three expansion/contraction members 110 are arranged so as to surround a predetermined space extending in their expansion/contraction directions. Accordingly, the expansion/contraction mechanism 10 can have stronger rigidity to the force in a direction orthogonal to the expansion/contraction direction, and the twisting around the expansion/contraction direction, which have been described above.

As a second feature, the expansion/contraction mechanism 10 does not require a slider mechanism for performing a linear motion expansion/contraction operation. In the existing pantograph structure, when an expansion/contraction operation is performed, for fixing the expansion/contraction direction to one direction, it is necessary to restrict motion in which a link member itself moves when a link member coupling angle θ changes. Accordingly, for performing a linear motion expansion/contraction operation, generally, a slider mechanism that moves an end portion of a link member arranged at the farthest end, in a direction orthogonal to the expansion/contraction direction in an expansion/contraction operation plane is provided. On the other hand, in the expansion/contraction mechanism 10, when attention is paid to one expansion/contraction member 110, in a similar manner, while it is necessary to restrict movement of a link member 110 itself when a link member coupling angle θ changes, for fixing the expansion/contraction direction to one direction, because relative positions of the three expansion/contraction members 110 are fixed by the connection members 120, the motion in which the link member 111 itself moves can be restricted even without additionally providing a slider mechanism. In this manner, in the expansion/contraction mechanism 10, because a linear motion expansion/contraction operation is enabled without providing a slider mechanism, a linear motion expansion/contraction operation can be implemented while reducing the number of components more than that in the pantograph structure.

In this manner, in the expansion/contraction mechanism 10, a high expansion/contraction ratio can be obtained similarly to the pantograph structure, and a higher strength that is not obtained in the pantograph structure can be realized.

In addition, the expansion/contraction mechanism 10 mainly includes only the expansion/contraction members 110 and the connection members 120 when members such as the pins 112 and the bearings are excluded, and the structures of these expansion/contraction members 110 and the connection members 120 are also extremely simple. In other words, because the expansion/contraction mechanism 10 has a simpler structure, a more lightweight and more compact configuration can be obtained. In this manner, the expansion/contraction mechanism 10 can also realize a high strength while realizing a high expansion/contraction ratio with a simpler configuration.

Here, as described above, the expansion/contraction mechanism 10 includes the plurality of expansion/contraction members 110 and the plurality of connection members 120, and the expansion/contraction members 110 include the plurality of link members 111 having substantially the same shape and the plurality of connection members 120 can all have substantially the same shape. In other words, when members such as the pins 112 and the bearings are excluded, the expansion/contraction mechanism 10 can be manufactured mainly by two members (link member 111 and connection member 120), and in addition, these two members have similar shapes. Thus, the manufacturing of a plurality of the members is also easy. In this manner, the expansion/contraction mechanism 10 also has such an advantage that manufacturing can be performed at low cost.

Here, the configuration of the expansion/contraction mechanism 10 is not limited to the example illustrated in FIGS. 1-4. For example, in the configuration example illustrated in FIGS. 1-4, the expansion/contraction member 110 includes the four link members 111, and accordingly, the four connection members 120 are provided, but the configuration of the expansion/contraction mechanism 10 is not limited to this example. In the expansion/contraction mechanism 10, the number of link members 111 included in the expansion/contraction member 110, and the number of connection members 120 that is accordingly decided may be arbitrarily set. In addition, the length of the link members 111 may also be arbitrarily set. Because an expansion/contraction ratio and an expansion/contraction length of the expansion/contraction members 110 (i.e. an expansion/contraction ratio and an expansion/contraction length of the expansion/contraction mechanism 10) are decided depending on the number and the length of the link members 111 included in the expansion/contraction member 110, the number and the length of the link members 111 included in the expansion/contraction members 110, and the number of the connection members 120 can be appropriately set in accordance with use application of the expansion/contraction mechanism 10, in such a manner that a desired expansion/contraction ratio and expansion/contraction length can be realized. In other words, the expansion/contraction mechanism 10 has an excellent configuration in which an expansion/contraction ratio and an expansion/contraction length can be easily changed by changing the number and the length of the link members 111 included in the expansion/contraction member 110. Nevertheless, in a case where the number of link members 111 included in the expansion/contraction member 110 is two or less, the expansion/contraction member 110 almost cannot perform an expansion/contraction operation. Thus, the number of link members 111 included in the expansion/contraction member 110 is preferably at least three or more.

In addition, for example, in the configuration example illustrated in FIGS. 1-4, the link members 111 have an elongated flat plate shape, but the shape of the link members 111 is not limited to this example. The link members 111 are only required to be elongated members, and the shape thereof may be an arbitrary shape. Nevertheless, from the viewpoint of a reduction in manufacturing cost, the shape is preferably a simple shape such as a flat plate shape illustrated in the drawings.

Note that, if the length of each of the link members 111 is made shorter, the expansion/contraction mechanism 10 can be formed to be thinner, and further downsizing is enabled. Nevertheless, because an expansion/contraction length becomes relatively short, for ensuring a predetermined expansion/contraction length while shortening the length of each of the link members 111, it becomes necessary to form the expansion/contraction member 110 by a larger number of link members 111. In this manner, because the length of the link members 111 largely affects the size and expansion/contraction performance (expansion/contraction ratio, expansion/contraction length, etc.) of the expansion/contraction mechanism 10, the length is preferably decided considering these factors.

In addition, for example, in the configuration example illustrated in FIGS. 1-4, the plurality of link members 111 all have substantially the same shape, but the shape of the link members 111 is not limited to this example. A part of all of the plurality of link members 111 may have shapes different from each other. For example, the expansion/contraction member 110 may be formed using a plurality of types of link members 111 having gradually-varying lengths, in such a manner that the lengths of the link members 111 become gradually shorter from one end toward another end. According to this configuration, the expansion/contraction mechanism 10 having a shape getting gradually thinner toward the other end can be formed. Nevertheless, from the above-described viewpoint of a reduction in manufacturing cost, all of the plurality of link members 111 preferably have substantially the same shape.

In addition, for example, a cover may be provided so as to cover the outer periphery of the expansion/contraction mechanism 10, which is not illustrated in FIGS. 1-4. The cover can be an accordion-shaped cover, for example. When the outer periphery of the expansion/contraction mechanism 10 is exposed as illustrated in the drawings, there is a risk that a finger of a human, a cable, or the like is pinched between the link members 111 by a motion of the expansion/contraction members 110 that is caused by an expansion/contraction operation. By providing the cover, such a risk can be avoided.

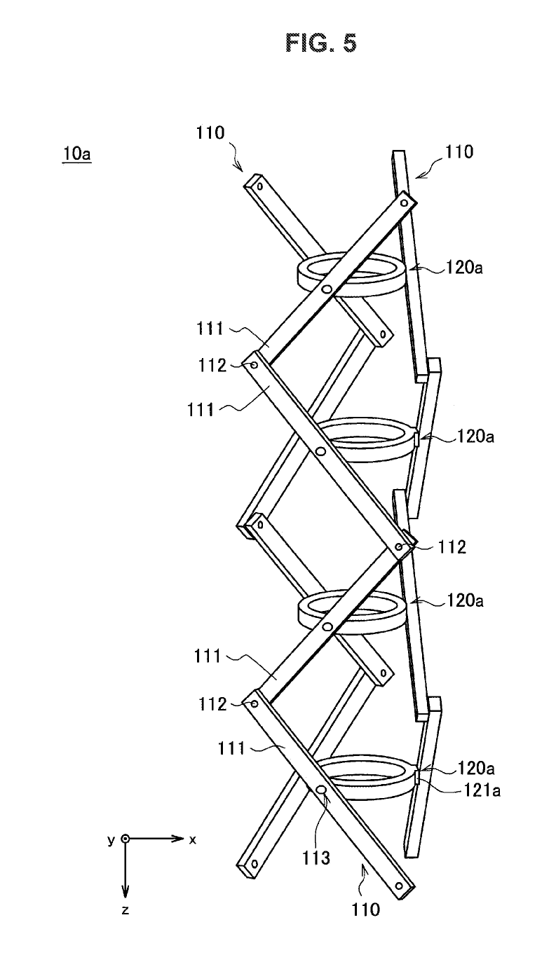

In addition, for example, in the configuration example illustrated in FIGS. 1-4, the connection members 120 have a substantially Y shape, but the shape of the connection members 120 is not limited to this example. The connection members 120 are only required to be arranged in a space surrounded by the three expansion/contraction members 110, and to connect these three expansion/contraction members 110 to each other, and the shape thereof may be an arbitrary shape. For example, protruding directions of three protruding portions 121 of the connection member 120 need not be on the same plane. In addition, for example, the connection members 120 may have a ring shape. FIG. 5 is a diagram illustrating a configuration of an expansion/contraction mechanism that uses the ring-shaped connection member, which is one modified example of the present embodiment.

Referring to FIG. 5, an expansion/contraction mechanism 10a according to this modified example includes three expansion/contraction members 110 that can expand and contract in the z-axis direction, and a plurality of connection members 120a inserted between these three expansion/contraction members 110. Note that the configuration of the expansion/contraction mechanism 10a is similar to the above-described expansion/contraction mechanism 10 except that the configuration of the connection members 120a is different. Accordingly, here, the detailed descriptions of items overlapping those of the expansion/contraction mechanism 10 will be omitted.

The connection members 120a have a ring shape, and protruding portions 121a respectively protruding toward the three expansion/contraction members 110 are formed on the outer peripheral surfaces. By these protruding portions 121a being respectively inserted into the opening portions 113 of the link members 111 of the three expansion/contraction members 110, these three expansion/contraction members 110 are connected to each other by the connection members 120a.

Even the expansion/contraction mechanism 10a having this configuration can implement an expansion/contraction operation similar to that of the above-described expansion/contraction mechanism 10. Here, according to this configuration, by the connection members 120a having a ring shape, in a case where a cable or the like needs to be laid from one end to another end of the expansion/contraction mechanism 10a (e.g. a case where a movable mechanism such as an end effector is provided at one end of the expansion/contraction mechanism 10a, and a cable or the like needs to be laid from another end of the expansion/contraction mechanism 10a to the end effector or the like for a manipulation of the end effector, etc.), it becomes possible to lay the cable in internal spaces of the plurality of connection members 120a. This can avoid such a situation that the cable is pinched between the link members 111 when the expansion/contraction mechanism 10a expands or contracts, and it becomes possible to smoothly perform the expansion/contraction operation.

### 2. Application Example

### 2-1. Parallel Link Mechanism

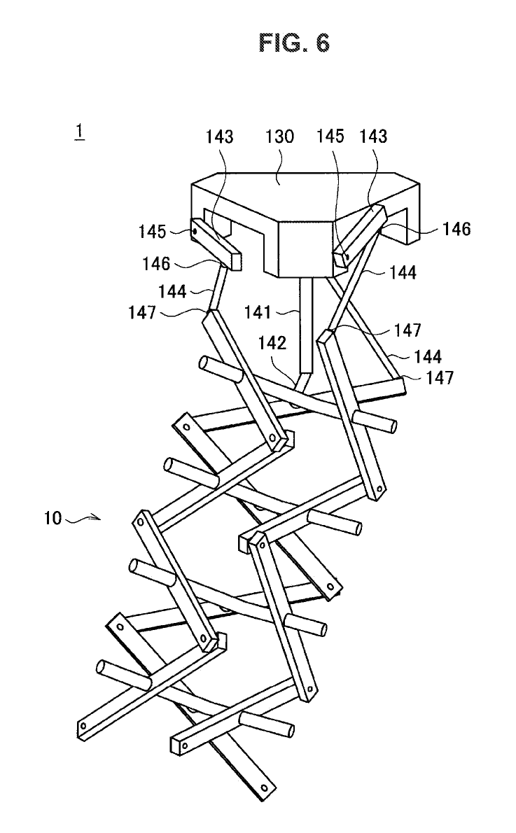

As an application example of the expansion/contraction mechanism 10 or 10a according to the present embodiment described above, a configuration of a parallel link mechanism to which the expansion/contraction mechanism 10 or 10a is applied will be described. FIG. 6 is a diagram illustrating a configuration of a parallel link mechanism according to the present embodiment. Note that FIG. 6 illustrates, as an example, a configuration example of a parallel link mechanism to which the expansion/contraction mechanism 10 described with reference to FIGS. 1-4 is applied, but it should be appreciated that the expansion/contraction mechanism 10a according to the modified example that has been described with reference to FIG. 5 can also be applied in place of the expansion/contraction mechanism 10.

Referring to FIG. 6, a parallel link mechanism 1 according to the present embodiment is formed by attaching the expansion/contraction mechanism 10 to a base member 130. Because the configuration of the expansion/contraction mechanism 10 illustrated in FIG. 6 is similar to that described with reference to FIGS. 1-4, here, the detailed description will be omitted.

The base member 130 is a substantially flat plate shaped member. In the example illustrated in the drawing, in response to three expansion/contraction operation planes in the expansion/contraction mechanism 10 being arranged so as to form a substantially regular triangular shape in the x-y plane, the base member 130 is also formed in such a manner that a plate surface thereof has a substantially regular triangular shape (note that regions corresponding to vertices are removed). Nevertheless, the shape of the base member 130 is not limited to the example illustrated in the drawing, and the shape of the base member 130 may be an arbitrary shape as long as the base member 130 can support the expansion/contraction mechanism 10 via a first support member 141, a second support member 143, and a third support member 144, which will be described later.

Note that, hereinafter, for the sake of convenience, a direction in which the base member 130 is provided in the parallel link mechanism 1 will also be referred to as “up”, and a direction in which the expansion/contraction mechanism 10 is provided with respect to the base member 130 will also be referred to as “down”.

The expansion/contraction mechanism 10 is arranged below the base member 130 in such a manner that an expansion/contraction direction thereof becomes substantially orthogonal to a plate surface of the base member 130. In other words, the expansion/contraction mechanism 10 is arranged in such a manner that the expansion/contraction direction becomes an up/down direction. Then, the parallel link mechanism 1 is formed by connecting the base member 130 and an upper end of the expansion/contraction mechanism 10 via the first support member 141, the second support member 143, and the third support member 144.

The first support member 141 is a rod-shaped member, and has one end connected to a substantially center of a bottom surface of the base member 130, and another end connected to a substantially center of a top surface of the connection member 120 located at the uppermost position of the expansion/contraction mechanism 10. In other words, the bottom surface of the base member 130 and the connection member 120 located at the uppermost position of the expansion/contraction mechanism 10 are connected by the first support member 141. At this time, an upper end of the first support member 141 and the base member 130 are fixedly connected in such a manner that the first support member 141 becomes substantially parallel to an expansion/contraction direction of the expansion/contraction mechanism 10. On the other hand, a lower end of the first support member 141 and the connection member 120 are connected via a joint mechanism 142 that can perform biaxial rotation, such as a universal joint, for example.

Both of the second support member 143 and the third support member 144 are rod-shaped members. Three sets of the second support members 143 and the third support members 144 are provided in total, and the configurations thereof are similar. Thus, here, the configuration will be described using one pair of the second support member 143 and the third support member 144.

One end of the second support member 143 is connected to a side surface of the base member 130. At this time, at a connection portion 145 thereof, the second support member 143 is pivotally supported so as to be rotatable around a rotational axis corresponding to a direction orthogonal to the side surface of the base member 130. On the other hand, to another end of the second support member 143, one end of the third support member 144 is connected by a joint mechanism 146 that can perform triaxial rotation, such as a ball joint, for example. Furthermore, another end of the third support member 144 is connected with an upper end of one expansion/contraction member 110 of the three expansion/contraction members 110 included in the expansion/contraction mechanism 10 (end portion of a link member 111 located at the uppermost position), by a joint mechanism 147 that can perform triaxial rotation, such as a ball joint, for example. Three sets of the second support members 143 and the third support members 144 having the configuration described above are respectively inserted between the base member 130 and respective upper ends of the three expansion/contraction members 110 included in the expansion/contraction mechanism 10.

In this manner, the base member 130 and the respective end portions of the three expansion/contraction members 110 are connected in such a manner that the three expansion/contraction members 110 are each rotatable around a rotational axis orthogonal to an expansion/contraction operation plane with respect to the base member 130. According to this configuration, by rotating the second support member 143 around the connection portion 145 with respect to the base member 130, the expansion/contraction mechanism 10 can be caused to perform an expansion/contraction operation in one direction and a rotational operation with two degrees of freedom. In other words, the parallel link mechanism 1 having three degrees of freedom can be formed.

In the present embodiment, the driving force for rotating the second support member 143 is applied by an actuator. Specifically, three actuators (not illustrated) are provided inside the base member 130. These three actuators are configured to be capable of independently applying, to the three second support members 143, driving force for rotating the three second support members 143 around the connection portions 145 with respect to the base member 130.

For example, by rotating all of the three second support members 143 in the same direction by the same angle by these three actuators, the expansion/contraction mechanism 10 can be caused to perform an expansion/contraction operation. In addition, by varying rotational directions and rotational angles of the three second support members 143 by these three actuators, the expansion/contraction mechanism 10 can be caused to perform only a rotational operation, or the expansion/contraction mechanism 10 can be caused to perform both of an expansion/contraction operation and a rotational operation.

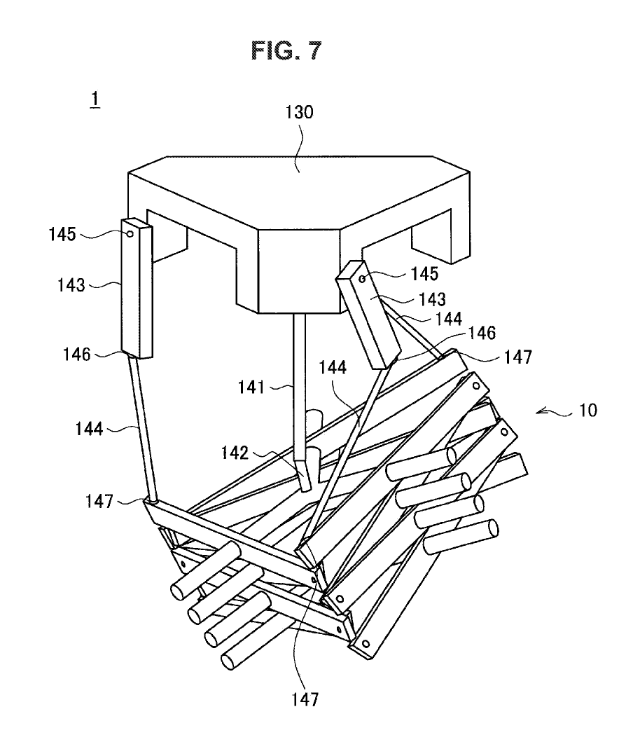

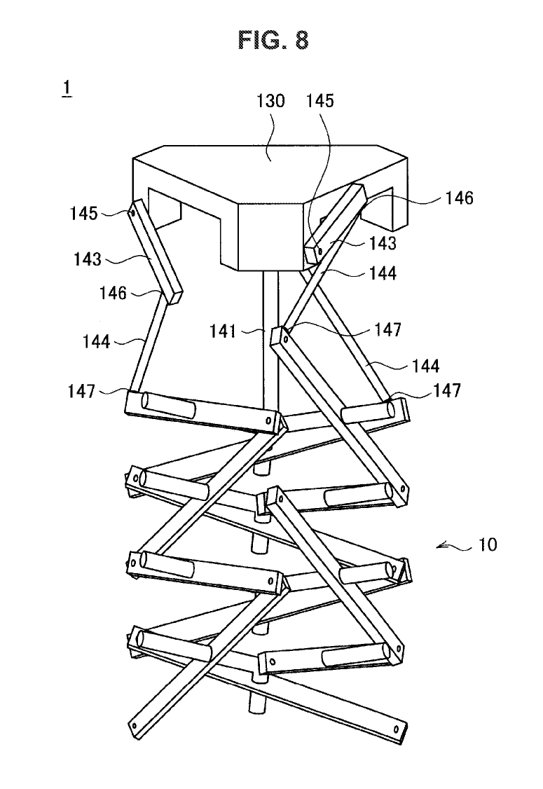

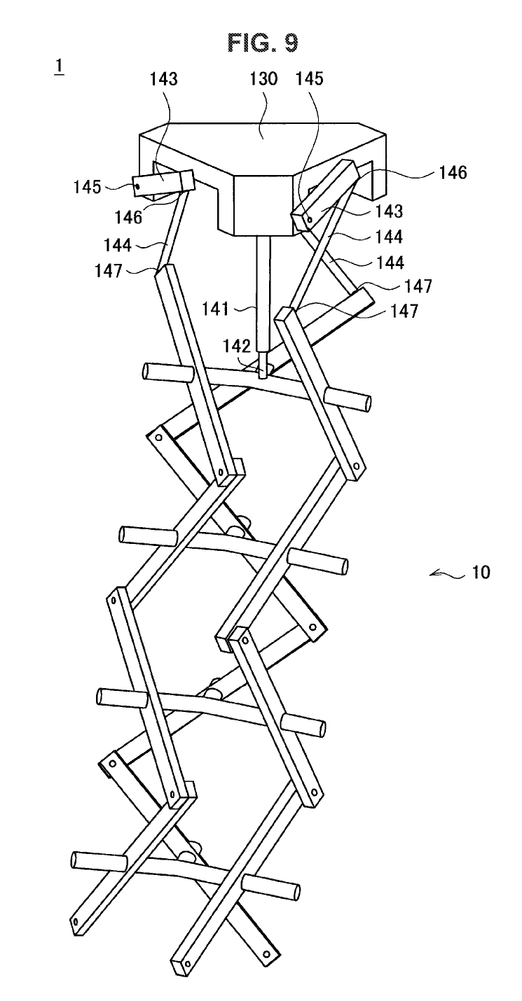

FIGS. 7-9 are diagrams illustrating an example of an operation of the parallel link mechanism 1. As illustrated in FIGS. 7-9, by appropriately driving the actuators, and appropriately controlling rotation of the second support members 143 around the connection portions 145 with respect to the base member 130, it becomes possible to cause the expansion/contraction mechanism 10 to perform an expansion/contraction operation and/or a rotational operation.

Note that, in this manner, in the parallel link mechanism 1, because an expansion/contraction operation and/or a rotational operation of the expansion/contraction mechanism 10 can be implemented by the actuators provided on the base member 130, the expansion/contraction mechanism 10 itself does not upsize, and a property of being compact and lightweight of the expansion/contraction mechanism 10 can be maintained.

The driving control of these three actuators can be performed by a control device (not illustrated). By the actuators appropriately rotating the respective second support members 143 by the control from the control device, a desired operation of the expansion/contraction mechanism 10 can be implemented. At this time, a control amount of each of the actuators may be automatically set by the control device in accordance with a predetermined program, or may be appropriately calculated and obtained by the control device in such a manner that a desired operation can be implemented in accordance with a command issued by an operator from the outside.

The configuration of the parallel link mechanism 1 according to the present embodiment has been described above. As described above, according to the present embodiment, while maintaining such a property of the expansion/contraction mechanism 10 that a high expansion/contraction ratio and a high strength can be realized with a simpler configuration, the parallel link mechanism 1 that can implement an operation with three degrees of freedom (an expansion/contraction operation in one direction and a rotational operation with two degrees of freedom) can be formed.

Here, generally, a parallel link mechanism refers to a machine structure in which two members are coupled in parallel by a plurality of link mechanisms, and is known to have a such an advantage that a large output can be generated as the entire parallel link mechanism because outputs of the respective actuators act in parallel even in a case where actuators for operating the respective link mechanisms are made compact. Also in the parallel link mechanism 1 according to the present embodiment, in a similar manner, because load applied when the expansion/contraction mechanism 10 is caused to perform an expansion/contraction operation and/or a rotational operation can be dispersed into the three actuators, even if an output of each actuator is small, it becomes possible to cause the expansion/contraction mechanism 10 to perform a desired operation. Accordingly, while maintaining a large output as the entire expansion/contraction mechanism 10, the actuators can be downsized, and the entire parallel link mechanism 1 can also be downsized.

In addition, in the parallel link mechanism 1 according to the present embodiment, as described above, by the driving of the actuators, an expansion/contraction operation and/or a rotational operation is performed by the expansion/contraction mechanism 10, and a mechanical power transmission mechanism such as a wire is not used. Accordingly, positioning of the expansion/contraction mechanism 10 in an operation can be performed more accurately.

Note that the configuration of the parallel link mechanism 1 according to the present embodiment is not limited to the example illustrated in the drawings. As described above, the parallel link mechanism 1 is a parallel link mechanism having three degrees of freedom, and for realizing the parallel link mechanism, it is only required that the base member 130 and the expansion/contraction mechanism 10 are connected by a joint mechanism that can perform biaxial rotation, and a mechanism for implementing a rotational operation of the expansion/contraction mechanism 10 and an expansion/contraction operation of the expansion/contraction mechanism 10 via the joint mechanism (in the above-described configuration example, the second support member 143, the third support member 144, the joint mechanism 146, 147) is provided, and the configuration thereof may be an arbitrary configuration. For example, in the above-described configuration example, the lower end of the first support member 141 and the connection member 120 can be connected by a universal joint, but the connection of these is only required to be performed via the joint mechanism 142 having two degrees of freedom, and the joint mechanism 142 needs not be a universal joint. For example, a connection structure of the lower end of the first support member 141 and the connection member 120 may be a structure in which two axes are not orthogonal.

In addition, by changing a connection method of the base member 130 and the expansion/contraction mechanism 10, a parallel link mechanism having another degree of freedom may be formed. For example, the connection of the base member 130 and the connection member 120 of the expansion/contraction mechanism 10 that are connected by a joint mechanism that can perform biaxial rotation, in the above-described configuration example may be performed by a joint mechanism that can perform triaxial rotation, such as a ball joint. According to this configuration, a parallel link mechanism having four degrees of freedom including an expansion/contraction operation in one direction and a rotational operation with three degrees of freedom can be realized. In this manner, in the present embodiment, by connecting the base member 130 and the expansion/contraction mechanism 10, a parallel link mechanism can be formed, but a connection method thereof may be an arbitrary connection method, and a parallel link mechanism having a variety of degrees of freedom may be formed in accordance with use application.

### 2-2. Four-Legged Robot

As another application example of the expansion/contraction mechanism 10 or 10a according to the present embodiment, a configuration of a four-legged robot having the expansion/contraction mechanism 10 or 10a in a leg portion will be described. As described above, when an operation such as going up or down stairs or steps is considered, a linear motion mechanism is preferably used for an expansion/contraction operation of a leg portion of a robot, rather than a rotational mechanism. Then, a moving robot is also required to be more compact and lightweight. Because the expansion/contraction mechanism 10 or 10a according to the present embodiment is compact and can realize a high expansion/contraction ratio and a high strength, the expansion/contraction mechanism 10 or 10a can be said to be preferably applied to a leg portion of a moving robot.

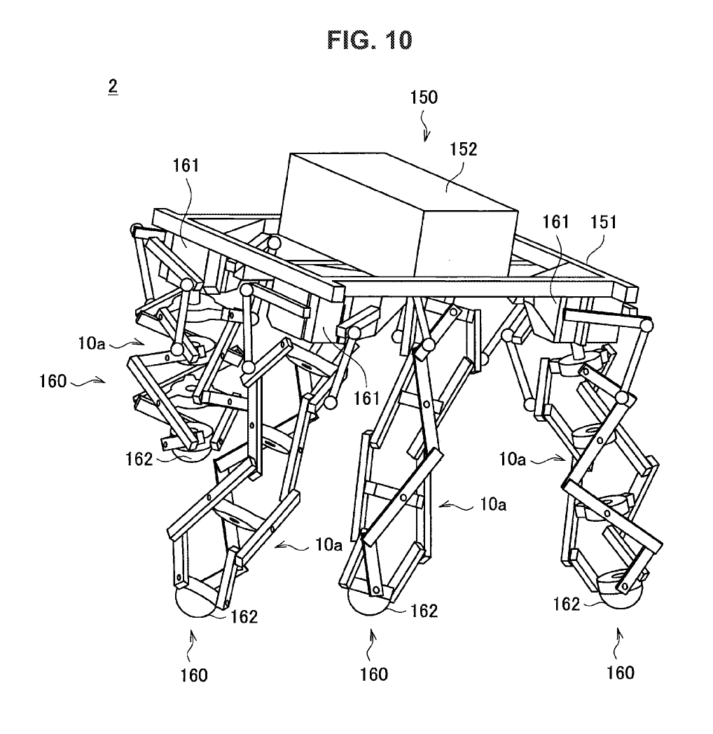

FIG. 10 is a diagram illustrating a configuration of a four-legged robot according to the present embodiment. Note that FIG. 10 illustrates, as an example, a configuration example in which the expansion/contraction mechanism 10a according to the modified example that has been described with reference to FIG. 5 is applied to a leg portion. It should be appreciated that the expansion/contraction mechanism 10 can also be applied in place of the expansion/contraction mechanism 10a.

Referring to FIG. 10, a four-legged robot 2 according to the present embodiment is formed by connecting four leg portions 160 to a main body portion 150. Note that, hereinafter, for the sake of convenience, a direction in which the main body portion 150 is provided in the four-legged robot 2 will also be referred to as “up”, and a direction in which the leg portions 160 are provided with respect to the main body portion 150 will also be referred to as “down”.

The main body portion 150 includes a base 151 having a substantially flat plate shape, and an electric portion 152 placed on the top surface of the base 151. On the electric portion 152, for example, a control unit that comprehensively controls an operation of the leg portions 160, and includes a control board and the like is mounted.

The leg portions 160 are respectively attached to the four corners of the bottom surface of the base 151. The leg portions 160 each include a base member 161 and the expansion/contraction mechanism 10a connected to the base member 161 so as to extend downward. Here, the base member 161 corresponds to the base member 130 illustrated in FIG. 6, and the configuration of the leg portions 160 is substantially similar to that of the parallel link mechanism 1 described with reference to FIG. 6. In this manner, the four-legged robot 2 can be said to be a four-legged robot to which the parallel link mechanism 1 according to the present embodiment is applied as the leg portions 160. As described above, because the parallel link mechanism 1 can realize a high expansion/contraction ratio and a high strength with a simpler configuration, by using the parallel link mechanism 1 as the leg portions 160, the leg portions 160 that are compact and have a high expansion/contraction ratio and a high strength can be realized.

Nevertheless, in the leg portion 160, the expansion/contraction mechanism 10a is used for the parallel link mechanism 1 illustrated in FIG. 6, in place of the expansion/contraction mechanism 10, and a hemispherical grounding member 162 for grounding is provided at the lower end thereof. Although there are these differences, the functions of the leg portions 160 can be similar to those of the parallel link mechanism 1. In other words, three actuators (not illustrated) respectively connected to the three expansion/contraction members 110 of the expansion/contraction mechanism 10a are provided on the base member 161 of the leg portion 160, and by appropriately driving these three actuators, an expansion/contraction operation and/or a rotational operation of the expansion/contraction mechanism 10a, that is to say, an expansion/contraction operation and/or a rotational operation of the leg portion 160 can be implemented.

The driving control of these actuators, that is to say, the control of an operation of the leg portions 160 can be performed by the control unit mounted on the electric portion 152. By the above-described actuators being appropriately driven by the control unit, and an operation of the leg portions 160 being appropriately controlled, an operation of the four-legged robot 2 such as walking or jump can be implemented. At this time, a control amount of each actuator may be automatically set by the control unit in accordance with a predetermined program, or may be appropriately calculated and obtained by the control unit in such a manner that a desired operation can be implemented in accordance with a command issued by an operator from the outside.

The configuration of the four-legged robot 2 according to the present embodiment has been described above. Note that, here, the configuration of the four-legged robot 2 has been described as an example in which the expansion/contraction mechanism 10 or 10a according to the present embodiment is applied to a leg portion of a robot, but a form of a robot to which the expansion/contraction mechanism 10 or 10a according to the present embodiment can be applied is not limited to this example. For a robot having a different number of leg portions, such as a two-legged robot, for example, the expansion/contraction mechanism 10 or 10a according to the present embodiment may be applied to the leg portions.

### 2-3. Other Application Examples

Aside from the above, the expansion/contraction mechanism 10 or 10a according to the present embodiment can be applied to a variety of use applications. For example, the expansion/contraction mechanism 10 or 10a can be preferably applied in the medical or caring field.

For example, in recent year, in a surgical operation, an arm device has been used for supporting a medical tool. Here, examples of the medical tool include a treatment tool such as forceps, tweezers, and a retractor, and an observation tool such as an endoscope and a microscope. There is such an advantage that, by supporting these using an arm device, a position can be fixed more stably even in a long-hour operation, as compared with a case of supporting these by a hand of a human. The expansion/contraction mechanism 10 or 10a can be preferably applied as an arm portion of this arm device. For example, the arm device can be formed by providing an end effector for supporting a medical tool, at one end of the expansion/contraction mechanism 10 or 10a.

Generally, in an operating room, there exist a number of objects such as medical staffs such as doctors and nurses, and various types of devices to be used in an operation. Thus, for effectively utilizing a limited space, devices to be used in an operating room are required to be more compact. Because the expansion/contraction mechanism 10 or 10a according to the present embodiment can be formed to be simpler and compact, the arm device to which the expansion/contraction mechanism 10 or 10a is applied is preferably used in an operating room.

In addition, from the viewpoint of safety, high positioning accuracy can be required for a medical arm device. In response to this, as described above, because positioning can be accurately performed according to the parallel link mechanism 1 including the expansion/contraction mechanism 10 or 10a, the parallel link mechanism 1 can also be preferably applied to a medical arm device.

On the other hand, in the caring use application, for example, application to a caring power assist suit can be expected. For example, there can be devised a power assist suit in which the expansion/contraction mechanism 10 or 10a is arranged to be positioned in a region corresponding to a major muscle of an arm portion and/or leg portion of a caretaker when the power assist suit is worn. According to the power assist suit, it becomes possible to support an operation of the caretaker by expanding or contracting the expansion/contraction mechanism 10 or 10a by an actuator so as to support expansion/contraction of the muscle, in accordance with a motion of the caretaker that has been detected by a sensor or the like. Because the expansion/contraction mechanism 10 or 10a has a simple configuration and is lightweight, by forming a power assist suit by the expansion/contraction mechanism 10 or 10a, weight saving of the power assist suit can be achieved, and burden placed when the power assist suit is worn can be reduced.

Alternatively, an arm device to which the expansion/contraction mechanism 10 or 10a is applied may be attached to a wheelchair. The arm device can be formed by providing an end effector for gripping various types of objects, at one end of the expansion/contraction mechanism 10 or 10a, for example. Because the expansion/contraction mechanism 10 or 10a has a high expansion/contraction ratio, in a contracted form, the expansion/contraction mechanism 10 or 10a is compact and space-saving, and can be expanded to reach a farther point only when necessary. Thus, for example, it becomes possible to grip an object placed at a distance, without moving a wheel chair itself, and convenience of a user can be drastically enhanced.

In addition, aside from the medical and caring fields, the expansion/contraction mechanism 10 or 10a may be applied to an industrial arm device to be used for assembly, inspection, and the like of a product in a factory. Because a high expansion/contraction ratio and a high strength can be realized with a simpler configuration in an arm device to which the expansion/contraction mechanism 10 or 10a is applied, such an arm device can be preferably used in a variety of use applications.

### 3. Modified Example

In the above-described embodiment, the expansion/contraction mechanism 10 or 10a includes the three expansion/contraction members 110. Nevertheless, the present embodiment is not limited to this example. From the viewpoint of strength, the expansion/contraction mechanism 10 or 10a preferably includes at least three expansion/contraction members 110, but the number of expansion/contraction members 110 is not limited, and the number of the expansion/contraction members 110 may be larger than three such as four or five, for example. Here, as one modified example of the present embodiment, a configuration of a parallel link mechanism to which an expansion/contraction mechanism including four expansion/contraction members 110 is applied will be described.

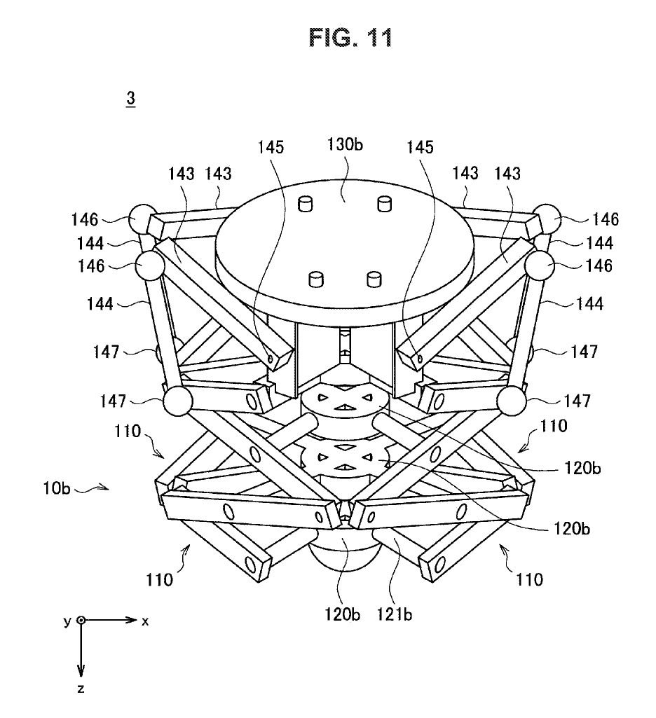

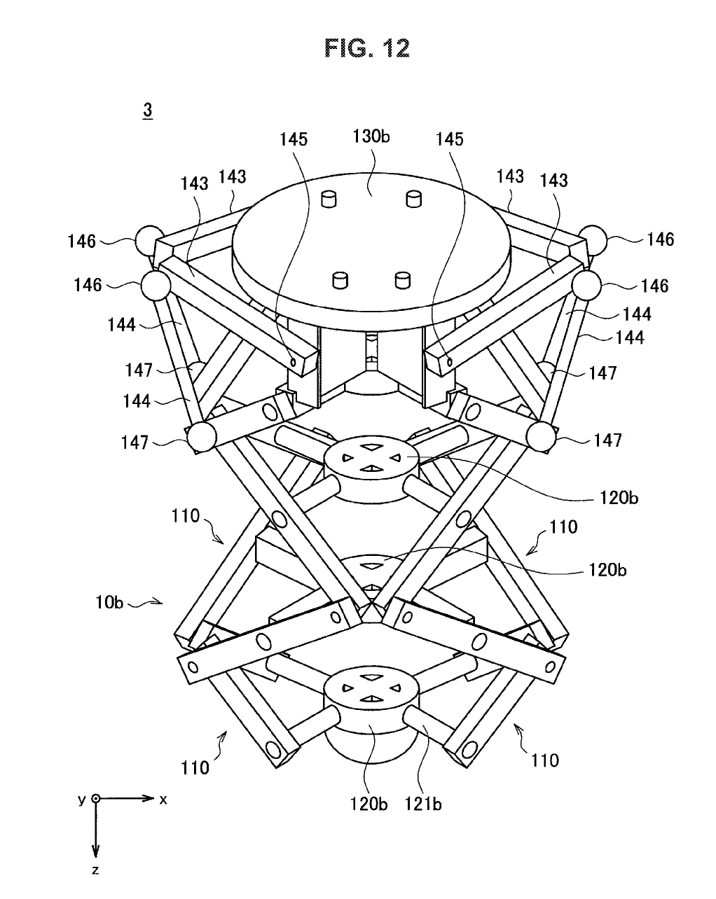

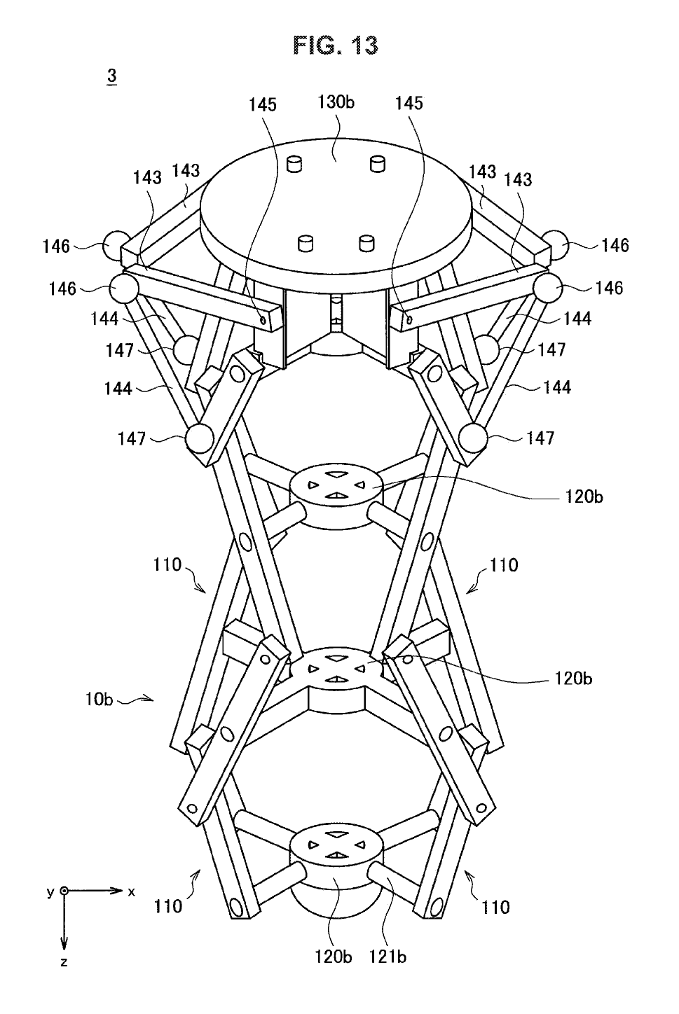

FIGS. 11-13 are diagrams for illustrating a configuration of a parallel link mechanism to which an expansion/contraction mechanism including four expansion/contraction members is applied, which is one modified example of the present embodiment, and describing an expansion/contraction operation thereof.

FIGS. 11-13 sequentially illustrate a state in which a parallel link mechanism 3 to which an expansion/contraction mechanism 10b according to this modified example is applied expands and contracts. Referring to FIGS. 11-13, the parallel link mechanism 3 according to this modified example is formed by attaching the expansion/contraction mechanism 10b to a base member 130b. Note that, hereinafter, for the sake of convenience, a direction in which the base member 130b is provided in the parallel link mechanism 3 will also be referred to as “up”, and a direction in which the expansion/contraction mechanism 10b is provided with respect to the base member 130b will also be referred to as “down”.

First of all, a configuration of the expansion/contraction mechanism 10b will be described. The expansion/contraction mechanism 10b according to this modified example includes four expansion/contraction members 110 that can expand and contract in the z-axis direction, and a plurality of connection members 120b inserted between these four expansion/contraction members 110. Note that the configuration of the expansion/contraction mechanism 10b is substantially similar to the above-described expansion/contraction mechanism 10 or 10a except that the number of expansion/contraction members 110 is different, and the configuration of connection members 120b is different. Accordingly, here, the detailed descriptions of items overlapping those of the expansion/contraction mechanism 10 or 10a will be omitted.

In the expansion/contraction mechanism 10b, the four expansion/contraction members 110 are arranged at substantially the same position in the z-axis direction so as not to contact each other and so as to surround a predetermined space extending in the z-axis direction (i.e. in such a manner that four expansion/contraction operation planes form a tetragon in the x-y plane), in a state in which all of their expansion/contraction directions face the z-axis direction. In addition, at this time, the four expansion/contraction members 110 are arranged in such a manner that their four expansion/contraction operation planes form a substantially regular tetragon in the x-y plane. Nevertheless, the configuration illustrated in the drawings is merely an example, and the arrangement of the expansion/contraction members 110 is not limited to this example. In this modified example, the four expansion/contraction members 110 are only required to be arranged, in a state in which their expansion/contraction directions face substantially the same direction, so as not to contact each other and so as to surround a predetermined space extending in the expansion/contraction direction. For example, the four expansion/contraction members 110 may be arranged in a state in which their positions in the z-axis direction are shifted from each other, or may be arranged in such a manner that their four expansion/contraction operation planes form another tetragon such as a rectangle, in the x-y plane.

Note that, in the configuration example illustrated in the drawings, all of the four expansion/contraction members 110 have lengths adjusted in such a manner that regions in which the connection members 120b are positioned in the z-axis direction become their upper ends and lower ends (i.e. only lengths of link members 111 positioned at an upper end and a lower end become substantially half of the length of other link members 111). Although there is such a difference, other configurations are similar to those of the expansion/contraction members 110 described with reference to FIGS. 1-4.

In a space surrounded by the four expansion/contraction members 110 arranged in this manner, the plurality of connection members 120b are provided. The connection members 120b have a substantially similar configuration to the above-described ring-shaped connection members 120a according to the modified example that are illustrated in FIG. 5. In other words, the connection members 120b have a ring shape, and protruding portions 121b respectively protruding toward the four expansion/contraction members 110 are formed on their outer peripheral surfaces. Nevertheless, in the connection member 120b, unlike the connection members 120a, a hollow portion of the ring shape is partially filled into an X shape in the x-y plane.

The hollow portion of the connection member 120b is partially filled in this manner for the following reason. As described later, when the expansion/contraction mechanism 10b is connected to the base member 130b, because the bottom surface of the base member 130b and the top surface of the connection member 120b positioned at an upper end are connected via a joint mechanism, a connection region needs to be ensured. By partially filling the hollow portion of the connection member 120b instead of entirely filling the hollow portion of the connection member 120b, it becomes possible to extend a cable or the like to the hollow portion, similarly to the connection member 120a, while ensuring the connection region.

The base member 130b corresponds to the above-described base member 130 of the parallel link mechanism 1 illustrated in FIG. 6, and is a member having a substantially flat plate shape that serves as a base of the parallel link mechanism 3. A connection structure of the base member 130b and the expansion/contraction mechanism 10b is substantially similar to that of the parallel link mechanism 1. In other words, by a rod-shaped first support member (not illustrated in FIGS. 11-13), the bottom surface of the base member 130b and the connection member 120b located at the uppermost position of the expansion/contraction mechanism 10b are connected by a joint mechanism (not illustrated in FIGS. 11-13). Here, in the parallel link mechanism 1, a joint mechanism that can perform biaxial rotation is used as the joint mechanism (i.e. corresponding to the joint mechanism 142), but in the parallel link mechanism 3, a joint mechanism that can perform triaxial rotation, such as a universal joint or a ball joint, for example, is used as the joint mechanism. In addition, by four sets of second support members 143 and third support members 144, the side surface of the base member 130 and the link member 111 located at the uppermost position of the four expansion/contraction members 110 are connected. At this time, at the connection portion 145 with the base member 130b, the second support member 143 is pivotally supported so as to be rotatable around a rotational axis corresponding to a direction parallel to the plate surface of the base member 130. In addition, in a connection region of the second support member 143 and the third support member 144, and a connection region of the third support member 144 and the link member 111, the joint mechanisms 146 and 147 that can perform triaxial rotation, such as a ball joint, for example, are provided.

According to this configuration, substantially similarly to the parallel link mechanism 1, by rotating the second support member 143 around the connection portion 145 with respect to the base member 130, the expansion/contraction mechanism 10b can be caused to perform an expansion/contraction operation in one direction and a rotational operation with three degrees of freedom. In other words, the parallel link mechanism 3 having four degrees of freedom can be formed.

A method of causing the parallel link mechanism 3 to perform an expansion/contraction operation and/or a rotational operation is similar to that of the parallel link mechanism 1. Specifically, four actuators configured to be capable of independently applying, to the four second support members 143, driving force for rotating the four second support members 143 around the connection portions 145 with respect to the base member 130 are provided inside the base member 130b. By appropriately rotating the second support members 143 around the respective connection portions 145 with respect to the base member 130b by these actuators, the expansion/contraction mechanism 10b can be caused to perform an expansion/contraction operation in one direction and a rotational operation with three degrees of freedom.

For example, by rotating all of the four second support members 143 in the same direction by the same angle by these four actuators, the expansion/contraction mechanism 10b can be caused to perform an expansion/contraction operation (see FIG. 11 to FIG. 13). In addition, although it is not illustrated, by varying rotational directions and rotational angles of the four second support members 143 by these four actuators, the expansion/contraction mechanism 10b can be caused to perform only a rotational operation, or the expansion/contraction mechanism 10b can be caused to perform both of an expansion/contraction operation and a rotational operation. At this time, because the parallel link mechanism 3 is configured to be capable of performing a rotational operation with three degrees of freedom, by appropriately driving the four actuators, an operation of twisting the expansion/contraction mechanism 10b around the z-axis is also enabled.

The driving control of these four actuators can be performed by a control device (not illustrated). By the actuators appropriately rotating the respective second support members 143 by the control from the control device, a desired operation of the expansion/contraction mechanism 10b can be implemented. At this time, a control amount of each of the actuators may be automatically set by the control device in accordance with a predetermined program, or may be appropriately calculated and obtained by the control device in such a manner that a desired operation can be implemented in accordance with a command issued by an operator from the outside.

The configuration of the parallel link mechanism 3 to which the expansion/contraction mechanism 10b including the four expansion/contraction members 110 is applied has been described above. Even in a case where the expansion/contraction mechanism 10b includes the four expansion/contraction members 110 as in this modified example, although weight increases as compared with the above-described expansion/contraction mechanisms 10 and 10a due to an increase in the number of the expansion/contraction members 110, the expansion/contraction mechanism 10b that is simpler, and has a higher expansion/contraction ratio and a higher strength, as compared with the existing expansion/contraction mechanism can be realized.

Note that, in the above-described configuration example, as a joint mechanism that connects the bottom surface of the base member 130b and the connection member 120b located at the uppermost position of the expansion/contraction mechanism 10b, a joint mechanism that can perform triaxial rotation is used, but as the joint mechanism, a joint mechanism that can perform biaxial rotation may be used similarly to the parallel link mechanism 1. In this case, the expansion/contraction mechanism 10b can be caused to perform an expansion/contraction operation in one direction and a rotational operation with two degrees of freedom. In other words, similarly to the parallel link mechanism 1, the parallel link mechanism 3 having three degrees of freedom can be formed. For example, in a case where the above-described operation of twisting around the z-axis is unnecessary, the parallel link mechanism 3 having three degrees of freedom may be formed in this manner. In the parallel link mechanism 3 according to this modified example, it is only required that, as a joint mechanism that connects the base member 130b and the connection member 120b, a joint mechanism that can perform rotation around at least two axes or more is used. Note that, in a similar manner, as for the parallel link mechanism 1, as the joint mechanism 142 that connects the base member 130 and the connection member 120, a joint mechanism that can perform triaxial rotation may be used. According to this configuration, the parallel link mechanism 1 having four degrees of freedom that can further perform a twisting operation around an expansion/contraction direction can be formed.

Note that, here, the configuration of the expansion/contraction mechanism 10b including the four expansion/contraction members 110 has been described, but an expansion/contraction mechanism may include a larger number of expansion/contraction members 110. For example, in a case where an expansion/contraction mechanism includes N (N≥5) expansion/contraction members 110, these N expansion/contraction members 110 are arranged at substantially the same positions in the z-axis direction so as not to contact each other and so as to surround a predetermined space extending in the z-axis direction (i.e. in such a manner that N expansion/contraction operation planes form an N-sided polygon in the x-y plane), in a state in which all of their expansion/contraction directions face the z-axis direction. Then, by the N expansion/contraction members 110 being connected to each other by a plurality of connection members 120, 120a, or 120b provided in the space surrounded by the N expansion/contraction members 110, the expansion/contraction mechanism can be formed.

### 4. Supplement

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, the configurations that the expansion/contraction mechanisms 10, 10a, and 10b, the parallel link mechanisms 1 and 3, and the four-legged robot 2 according to the embodiment and the modified examples described above can have can be applied with being combined with each other within a possible range. For example, the leg portions 160 of the four-legged robot 2 may be formed by the parallel link mechanism 3. In addition, for example, in the parallel link mechanism 3, the connection member 120 or 120a may be used in place of the connection member 120b. In addition, for example, in the expansion/contraction mechanism 10 or 10a, the connection member 120b may be used in place of the connection member 120 or 120a. Aside from these, all the configurations described above may be appropriately combined within a possible range.

Here, the control device for operating the expansion/contraction mechanism 10 or 10a, and for operating the parallel link mechanism 1 or 3, and the control unit for operating the leg portions 160 of the four-legged robot 2 that have been described in the above-described embodiment include, for example, a processor such as a Central Processing Unit (CPU). By the processors of the control device and the control unit performing arithmetic processing in accordance with a predetermined program, driving of respective actuators for operating these can be appropriately controlled. Note that specific device configurations of the control device and the control unit are not limited. For example, the control device may be a control board on which a processor, a storage element such as a memory, and the like are mounted. In this case, in the parallel link mechanism 1 or 3, the control board may be mounted on the base member 130 or 130b. Alternatively, the control device may be a general-purpose information processing device such as a Personal Computer (PC) that is installed on the outside of the expansion/contraction mechanism 10 or 10a or the parallel link mechanism 1 or 3. In addition, the control unit may also include various types of devices that can perform arithmetic processing in accordance with a predetermined program, such as the above-described control board.

Note that, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An expansion/contraction mechanism including:

at least three expansion/contraction members that are formed by coupling respective ends of a plurality of link members sequentially rotatably to each other, and that are capable of performing expansion/contraction operation in predetermined expansion/contraction directions by adjusting an angle between the mutually-coupled link members; and

a plurality of connection members that are provided with being aligned along the expansion/contraction directions in a space surrounded by the at least three expansion/contraction members arranged in a state in which the expansion/contraction directions face a substantially same direction, and that are configured to connect the at least three expansion/contraction members to each other,

in which each of the plurality of connection members pivotally supports the respective link members of the at least three expansion/contraction members that are positioned in a direction orthogonal to the expansion/contraction directions when viewed from itself, so as to be rotatable around itself.

(2)

The expansion/contraction mechanism according to (1), in which the number of the expansion/contraction members is three, and

the three expansion/contraction members are arranged in such a manner that expansion/contraction operation planes that are planes on which the expansion/contraction members in the three expansion/contraction members perform expansion/contraction operation form a triangular shape in a plane orthogonal to the expansion/contraction direction.

(3)

The expansion/contraction mechanism according to (2), in which the triangular shape formed by the expansion/contraction operation planes is a substantially regular triangular shape.

(4)

The expansion/contraction mechanism according to (1), in which the number of the expansion/contraction members is four, and

the four expansion/contraction members are arranged in such a manner that expansion/contraction operation planes that are planes on which the expansion/contraction members in the four expansion/contraction members perform an expansion/contraction operation form a tetragon in a plane orthogonal to the expansion/contraction direction.

(5)

The expansion/contraction mechanism according to any one of (1) to (4), in which the connection members are provided as many as the number of the link members included in the one expansion/contraction member, and

the plurality of connection members are respectively arranged at positions corresponding to the link members included in the one expansion/contraction member.

(6)

The expansion/contraction mechanism according to any one of (1) to (5), in which the number of the link members included in the one expansion/contraction member is three or more.

(7)

The expansion/contraction mechanism according to any one of (1) to (6), in which lengths of the plurality of link members included in each of the at least three expansion/contraction members are substantially same.

(8)

The expansion/contraction mechanism according to any one of (1) to (6), in which lengths of the plurality of link members included in each of the at least three expansion/contraction members become gradually shorter from one end of the expansion/contraction direction toward another end.

(9)

The expansion/contraction mechanism according to any one of (1) to (8), in which the connection member has a ring shape having an opening portion penetrating in the expansion/contraction direction.

(10)

The expansion/contraction mechanism according to any one of (1) to (9), in which an outer periphery is covered by an accordion-shaped cover.

(11)

The expansion/contraction mechanism according to any one of (1) to (10), in which the plurality of link members included in each of the at least three expansion/contraction members have a substantially same shape, and the plurality of connection members have a substantially same shape.

(12)

The expansion/contraction mechanism according to any one of (1) to (11), in which an actuator is provided on at least one of connection portions of the connection members and the link members, and

expansion/contraction operation is performed when the actuator rotates the link member around the connection portion of the connection member and the link member.

(13)

The expansion/contraction mechanism according to any one of (1) to (12), in which a parallel link mechanism is formed by connecting a base member to one end in an expansion/contraction direction of the expansion/contraction mechanism.

(14)

The expansion/contraction mechanism according to (13), in which the parallel link mechanism capable of performing expansion/contraction operation with one degree of freedom and rotational operation with two degrees of freedom is formed by connecting the base member and the connection member positioned at one end in the expansion/contraction direction of the expansion/contraction mechanism via a joint mechanism capable of performing biaxial rotation.

(15)

The expansion/contraction mechanism according to (13) or (14), in which the base member and respective end portions of the at least three expansion/contraction members are connected in such a manner that each of the at least three expansion/contraction members is rotatable with respect to the base member around a rotational axis orthogonal to an expansion/contraction operation plane that is a plane on which the expansion/contraction member performs expansion/contraction operation,

the base member is provided with a number of actuators corresponding to the number of the expansion/contraction members, the actuators being configured to apply, to the base member, respective driving forces for rotating the at least three expansion/contraction members, and

at least either of expansion/contraction operation or rotational operation of the expansion/contraction mechanism is executed when the respective actuators rotates the at least three expansion/contraction members with respect to the base member.

(16)

A four-legged robot including:

four leg portions each formed by an expansion/contraction mechanism,

in which the expansion/contraction mechanism includes
at least three expansion/contraction members that are formed by coupling respective ends of a plurality of link members sequentially rotatably to each other, and that is capable of performing expansion/contraction operation in predetermined expansion/contraction directions by adjusting an angle between the mutually-coupled link members, and
a plurality of connection members that are provided with being aligned along the expansion/contraction directions in a space surrounded by the at least three expansion/contraction members arranged in a state in which the expansion/contraction directions face a substantially same direction, and that are configured to connect the at least three expansion/contraction members to each other, and

each of the plurality of connection members pivotally supports the respective link members of the at least three expansion/contraction members that are positioned in a direction orthogonal to the expansion/contraction directions when viewed from itself, so as to be rotatable around itself.

### REFERENCE SIGNS LIST

1, 3 parallel link mechanism
2 four-legged robot
10, 10a, 10b expansion/contraction mechanism
110 expansion/contraction member
111 link member
112 pin
113 opening portion
120, 120a, 120b connection member
121, 121a, 121b protruding portion
130, 130b, 161 base member
141 first support member
142, 146, 147 joint mechanism
143 second support member
144 third support member
150 main body portion
151 base
152 electric portion
160 leg portion
162 grounding member

1. An expansion/contraction mechanism comprising:
at least three expansion/contraction members that are formed by coupling respective ends of a plurality of link members sequentially rotatably to each other, and that are capable of performing expansion/contraction operation in predetermined expansion/contraction directions by adjusting an angle between the mutually-coupled link members; and
a plurality of connection members that are provided with being aligned along the expansion/contraction directions in a space surrounded by the at least three expansion/contraction members arranged in a state in which the expansion/contraction directions face a substantially same direction, and that are configured to connect the at least three expansion/contraction members to each other,
wherein each of the plurality of connection members pivotally supports the respective link members of the at least three expansion/contraction members that are positioned in a direction orthogonal to the expansion/contraction directions when viewed from itself, so as to be rotatable around itself.

2. The expansion/contraction mechanism according to claim 1, wherein a number of the expansion/contraction members is three, and
the three expansion/contraction members are arranged in such a manner that expansion/contraction operation planes that are planes on which the expansion/contraction members in the three expansion/contraction members perform expansion/contraction operation form a triangular shape in a plane orthogonal to the expansion/contraction direction.

3. The expansion/contraction mechanism according to claim 2, wherein the triangular shape formed by the expansion/contraction operation planes is a substantially regular triangular shape.

4. The expansion/contraction mechanism according to claim 1, wherein a number of the expansion/contraction members is four, and
the four expansion/contraction members are arranged in such a manner that expansion/contraction operation planes that are planes on which the expansion/contraction members in the four expansion/contraction members perform an expansion/contraction operation form a tetragon in a plane orthogonal to the expansion/contraction direction.

5. The expansion/contraction mechanism according to claim 1, wherein the connection members are provided as many as a number of the link members included in the one expansion/contraction member, and
the plurality of connection members are respectively arranged at positions corresponding to the link members included in the one expansion/contraction member.

6. The expansion/contraction mechanism according to claim 1, wherein a number of the link members included in the one expansion/contraction member is three or more.

7. The expansion/contraction mechanism according to claim 1, wherein lengths of the plurality of link members included in each of the at least three expansion/contraction members are substantially same.

8. The expansion/contraction mechanism according to claim 1, wherein lengths of the plurality of link members included in each of the at least three expansion/contraction members become gradually shorter from one end of the expansion/contraction direction toward another end.

9. The expansion/contraction mechanism according to claim 1, wherein the connection member has a ring shape having an opening portion penetrating in the expansion/contraction direction.

10. The expansion/contraction mechanism according to claim 1, wherein an outer periphery is covered by an accordion-shaped cover.

11. The expansion/contraction mechanism according to claim 1, wherein the plurality of link members included in each of the at least three expansion/contraction members have a substantially same shape, and
the plurality of connection members have a substantially same shape.

12. The expansion/contraction mechanism according to claim 1, wherein an actuator is provided on at least one of connection portions of the connection members and the link members, and
expansion/contraction operation is performed when the actuator rotates the link member around the connection portion of the connection member and the link member.

13. The expansion/contraction mechanism according to claim 1, wherein a parallel link mechanism is formed by connecting a base member to one end in an expansion/contraction direction of the expansion/contraction mechanism.

14. The expansion/contraction mechanism according to claim 13, wherein the parallel link mechanism capable of performing expansion/contraction operation with one degree of freedom and rotational operation with two degrees of freedom is formed by connecting the base member and the connection member positioned at one end in the expansion/contraction direction of the expansion/contraction mechanism via a joint mechanism capable of performing biaxial rotation.

15. The expansion/contraction mechanism according to claim 14, wherein the base member and respective end portions of the at least three expansion/contraction members are connected in such a manner that each of the at least three expansion/contraction members is rotatable with respect to the base member around a rotational axis orthogonal to an expansion/contraction operation plane that is a plane on which the expansion/contraction member performs expansion/contraction operation,
the base member is provided with a number of actuators corresponding to a number of the expansion/contraction members, the actuators being configured to apply, to the base member, respective driving forces for rotating the at least three expansion/contraction members, and
at least either of expansion/contraction operation or rotational operation of the expansion/contraction mechanism is executed when the respective actuators rotates the at least three expansion/contraction members with respect to the base member.

16. A four-legged robot comprising:
four leg portions each formed by an expansion/contraction mechanism,
wherein the expansion/contraction mechanism includes
at least three expansion/contraction members that are formed by coupling respective ends of a plurality of link members sequentially rotatably to each other, and that is capable of performing expansion/contraction operation in predetermined expansion/contraction directions by adjusting an angle between the mutually-coupled link members, and
a plurality of connection members that are provided with being aligned along the expansion/contraction directions in a space surrounded by the at least three expansion/contraction members arranged in a state in which the expansion/contraction directions face a substantially same direction, and that are configured to connect the at least three expansion/contraction members to each other, and
each of the plurality of connection members pivotally supports the respective link members of the at least three expansion/contraction members that are positioned in a direction orthogonal to the expansion/contraction directions when viewed from itself, so as to be rotatable around itself.
